(19) United States
(12) Patent Application Publication
(10) Pub. No.: US 2018/0171721 A1
(43) Pub. Date: Jun. 21, 2018

(54) Drill Bit and Production Method

(71) Applicant: HILTI AKTIENGESELLSCHAFT, Schaan (LI)

(72) Inventors: Guenter DOMANI, Weissensberg (DE); Carsten PETERS, Sax (CH); Florian SCHROEDER, Buchs (CH)

(73) Assignee: Hilti Aktiengesellschaft, Schaan (LI)

(21) Appl. No.: 15/737,226

(22) PCT Filed: Jun. 14, 2016
(86) PCT No.: PCT/EP2016/063565

§ 371 Date: Dec. 15, 2017

(30) Foreign Application Priority Data
Jun. 17, 2015 (EP) 15172463.0

(51) Int. Cl. E21B 10/44; B23B 51/02; B21H 3/10; B21K 5/04; B23P 15/32; B28D 1/14

(52) U.S. Cl. CPC E21B 10/445; B23B 51/02; B21H 3/10; B21K 5/04; B23B 2226/75; B28D 1/146; B23B 2224/00; B23B 2251/406; B23B 2251/408; B23P 15/32

(57) ABSTRACT

A drill bit has, along a drill bit axis, a drilling head, a multi-start helix made of two or more helical coils, and an insertion end. The helix has a helix slope and a pitch in a delivery region. In an outlet region of the helix, the outlet region being directed towards the insertion end, the helical coils merge continuously, within a first portion, from an orientation in alignment with the helix slope into an orientation parallel to the drill bit axis. A length of the first portion is at least one quarter of the pitch of the delivery region. The helical coils, in a second portion, are oriented parallel to the drill bit axis.

This application claims the priority of International Application No. PCT/EP2016/063565, filed Jun. 14, 2016, and European Patent Document No. 15172463.0, filed Jun. 17, 2015, the disclosures of which are expressly incorporated by reference herein.

### BACKGROUND AND SUMMARY OF THE INVENTION

The present invention relates to a drill bit, in particular for breaking down mineral construction materials and a production method for the drill bit.

A drill bit for breaking down mineral construction materials, e.g., U.S. Pat. No. 7,628,232, has a drilling head with a chisel edge. The chisel edge is impacted by a percussion mechanism of a hand-held power tool periodically against the construction material. In doing so, the construction material is pounded. The drill bit is rotated continuously around its drill-bit axis whereby the chisel edge is rotated at an angle from one impact to the next. The drilling head can also break material off the borehole wall during rotation, whereby a circular borehole results. The helix is subject to high mechanical loads, in particular when the user cross-loads the drill bit when drilling.

The drill bit according to the invention, which is preferably designed for percussive processing of mineral and reinforced construction materials, has, along a drill-bit axis, a multi-start helix made of two or more helical coils and an insertion end. The helix has a helix slope and a pitch in a delivery region. In an outlet region of the helix, the outlet region being directed towards the insertion end, the helical coils merge continuously, within a first portion, from orientation in alignment with the helix slope into orientation parallel to the drill-bit. A length of the portion is at least quarter the pitch of the delivery region. The helical coils, in a second portion, are oriented parallel to the drill-bit axis. The delivery region with the slightly curved first portion and the straight second portion proves helpful at receiving bending loads and damping the bending stresses between the drilling head and the insertion end.

In one configuration, a cross-section in the first portion and the delivery region is constant. The cross-section has only one orientation changing along the drill-bit axis due to the helical shape of the helix. However, the cross-section can be brought into full alignment at any point within the first portion and the delivery region by suitable rotation around the axis. The helix thus advances into the outlet region, but its helix slope increases and reaches 90 degrees. The helical coils do not change their dimensions, i.e., height and thickness. Bending stresses can be uniformly introduced and do not generate local peaks.

In one configuration, the helical grooves have constant depths in the delivery region and the first portion.

In one configuration, the helix slope of the helical coils decreases in the first region with respect to the drill-bit axis at a rate of between 0.25 degrees and 2 degrees per degree in the direction of rotation of the helix. The helix slope preferably changes continuously over the entire length of the first region. The helix slope can be between 30 and 70 degrees in the delivery region, the helix slope in the first region continually decreases until it reaches this helix slope.

In one configuration, a length of the two portions is between a quarter and a triple the pitch of the delivery region. The second portion extends the drill bit unnecessarily, it also has no and only a very low delivery effect for the drill dust. This second portion can, however, increase the fatigue strength of the drill bit. A cross-section of the second portion can be constant over at least half the second portion.

A production method for the drill bit can have the following steps. A plurality of straight longitudinal grooves oriented parallel to the axis of the blank are formed into a cylindrical blank. The longitudinal grooves are twisted with a twisting tool. A partial portion of the longitudinal grooves are twisted such that the longitudinal grooves of the blank are continually converted in the delivery region from the orientation parallel to the axis into the orientation according to the helix slope. The first partial portion has a length which corresponds to at least quarter of the pitch. A second partial portion of the longitudinal grooves is removed by the twisting.

The longitudinal grooves are preferably formed by longitudinal rolling.

The following description explains the invention based on exemplary embodiments and figures.

### BRIEF DESCRIPTION OF THE DRAWINGS

FIG. 1 illustrates a drill bit;

FIG. 2 is a cross-section through the drill bit in the plane II-II;

FIG. 3 is a cross-section through the drill bit in the plane

FIG. 4 is a cross-section through the drill bit in the plane IV-IV;

FIG. 5 is a cross-section through the drill bit in the plane V-V;

FIG. 6 is a cross-section through the drill bit in the plane VI-VI;

FIG. 7 is a longitudinal section through a straight portion of the helix;

FIG. 8 is a rolled representation of the helix;

FIG. 9 illustrates rolling of a blank;

FIG. 10 is a cross-section of FIG. 9;

FIG. 11 illustrates a semi blank;

FIG. 12 illustrates converting the semi blank with a rotating matrix;

FIG. 13 is a cross-section through a support matrix; and

FIG. 14 is a cross-section through a matrix.

### DETAILED DESCRIPTION OF THE DRAWINGS

Identical or functionally-identical elements are indicated with identical reference numerals in the figures, unless otherwise indicated.

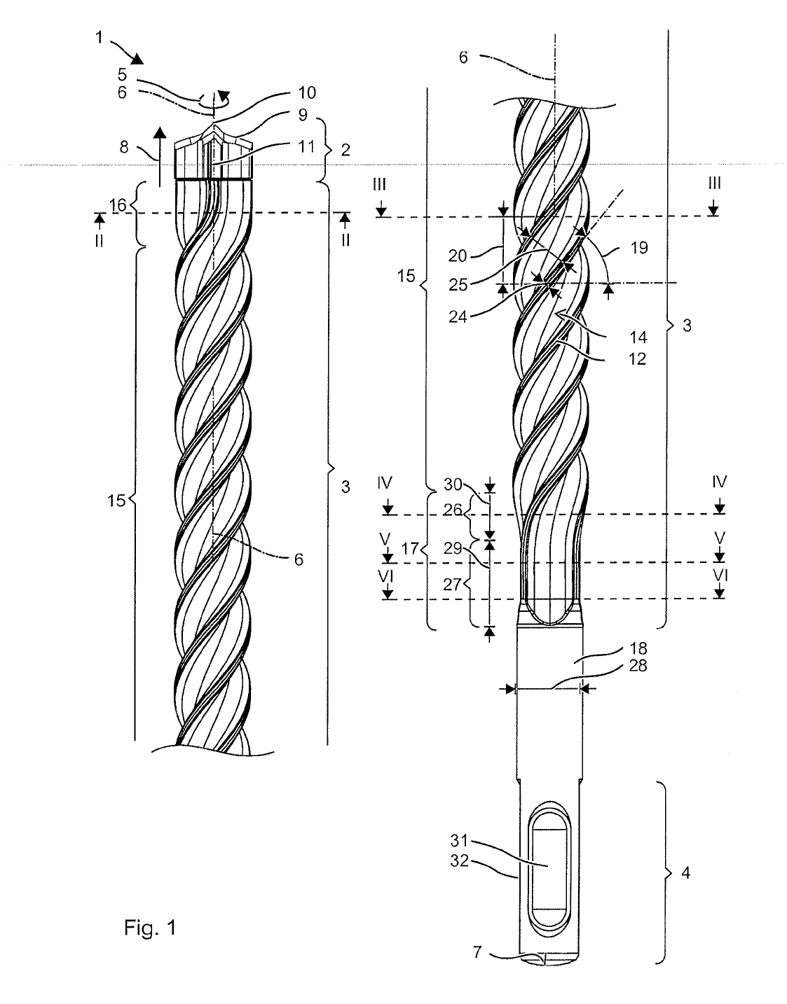

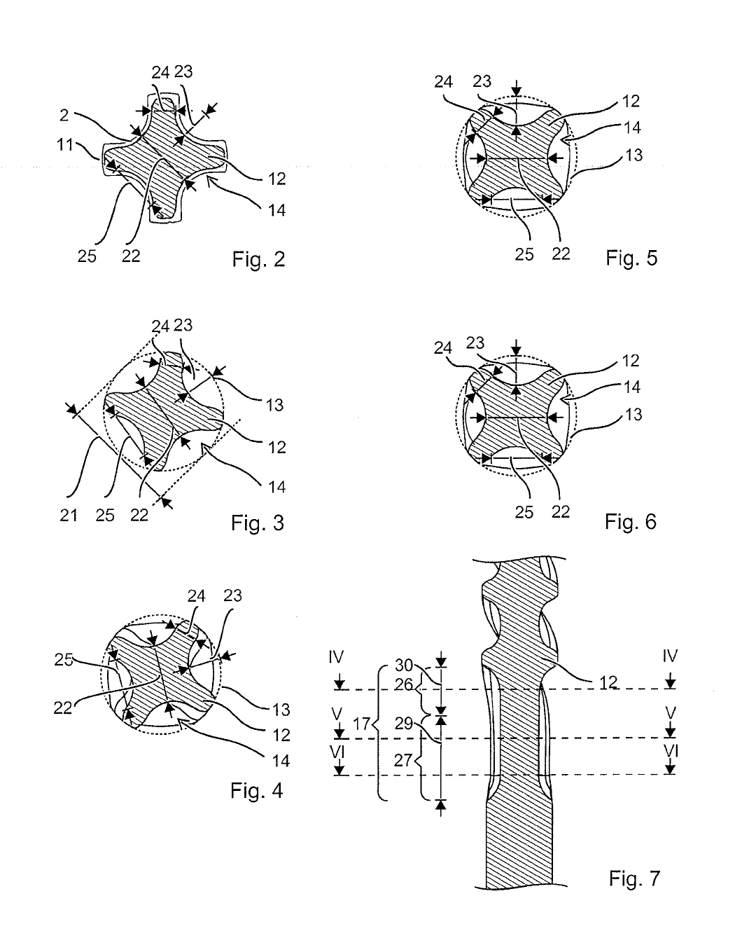

FIG. 1 shows an exemplary drill bit 1. The drill bit 1 has a drilling head 2, a helix 3 and an insertion end 4. The drill bit 1 is for example designed to break down mineral materials, e.g., reinforced concrete. The drill bit 1 is rotated during operation in a direction of rotation 5 around its longitudinal axis 6 (drill-bit axis). The drill bit 1 can also be used in a hand-held power tool which has a corresponding rotational drive. A percussion mechanism of the hand-held power tool impacts the free end 7 of the insertion end 4 periodically. The shock wave of the impacts runs through the helix 3 in the direction of impact 8 to the drilling head 2. The drilling head 2 shatters the material. The rotational movement ensures firstly that the drilling head 2 impacts the substrate at different orientations and the borehole is tapped out evenly and it secondly affects the transport of the drill cutting from the borehole by means of the helix 3.

The exemplary drilling head 2 has four chisel edges 9. The chisel edges 9 merge to a tip 10 on the drill-bit axis 6. The tip 10 is preferably the highest point in the direction of impact 8 which thus first contacts the material during drilling. The chisel edges 9 can increase in the radial direction externally towards the drill-bit axis 6 along the direction of impact 8. The chisel edges 9 all point in the direction of impact 8. The chisel edge 9 is formed by a bevel running in the direction of rotation and a bevel running behind which both point in the direction of impact 8. The two bevels are inclined towards each other; the roof angle at the chisel edge 9 is greater than 45 degrees, preferably greater than 60 degrees and smaller than 120 degrees. The chisel edges 9 can all be shaped the same or be different in pairs. The drilling head 2 has four break-off edges 11 which run parallel to the drill-bit axis 6. The break-off edges 11 merge into the chisel edges 9. The break-off edges 11 define the diameter of the drilling head 2. The number of chisel edges 9 and the break-off edges 11 can be selected depending on the diameter of the drill bit 1. For example, in the case of a drill bit 1 of small diameter, the drilling head 2 can have two chisel edges 9; a drilling head 2 of large diameter can have more than four chisel edges 9 and corresponding number of break-off edges 11.

The drilling head 2 is preferably produced from a sintered material, in particular tungsten carbide. The chisel edges 9 and the break-off edges 11 are preferably connected to each other monolithically and continuously, in particular without joining areas.

The helix 3 of the drill bit 1 has for example four helical coils 12. The number of helical coils 12 is preferably equal to the number of chisel edges 9. The helical coils 12 run along the drill-bit axis 6 repeatedly around this drill-bit axis 6. The helical coils 12 plot a cylindrical envelope 13 during rotation of the drill bit 1. Respectively adjacent helical coils 12 enclose a helical groove 14 between them which is viewed in the radial direction through the envelope 13 as a geometrically limited. The drill cutting is transported into the helical grooves 14 through the helical coils 12 along the drill-bit axis 6.

The helix 3 has different portions along the drill-bit axis 6 which, in order to satisfy different requirements, differ in the slope of the helical coils 12. A delivery region 15 is the dominating portion and serves to deliver the drill cutting. The delivery region 15 typically extends by more than 80% of the length of the helix 3. The delivery region 15 can directly border on the drilling head 2, alternatively there is a fastening region 16 between the drilling head 2 and the drilling head 2, which is designed for particular requirements for fastening the drilling head 2 to the helix 3. The helix 3 ends at its end 7 pointing to the insertion end 4 with an outlet region 17. The outlet region 17 merges into the cylindrical shaft 18 of the insertion end 4.

A helix slope 19 of the helical coils 12 is located in the delivery region 15, i.e., an inclination of the helical coils 12 with respect to a plane perpendicular to the drill-bit axis 6, in a range between 35 degrees and 70 degrees. The helix slope 19 of the helical coils 12 is preferably constant over the entire delivery region 15. The constant helix slope 19 ensures an even transport of the drill cutting in the helix 3. The constant helix slope 19 requires a constant pitch 20 of the helix 3. In an alternative configuration, the helix slope 19 and the pitch 20 can increase in the direction of impact 8. The helix 3 has, in the delivery region 15, a cross-section (FIG. 3) remaining constant along the drill-bit axis 6 which rotates continually around the drill-bit axis 6. The cross-section can, inter alia, be described by the helix diameter 21, a core diameter 22, a height of the helical coils 12 and depth 23 of the helical grooves 14, an average thickness 24 of the helical coils 12 and an average width 25 of the helical grooves 14. The helix diameter 22 is the diameter of the drill bit 1 or the envelope 13 of the helix 3, i.e., the smallest hollow cylinder, in which the helix 3 can be rotated around its drill-bit axis 6. The core diameter 22 is the diameter of the largest circle which can be fully inscribed into the cross-section of the helix 3. The average thickness 24 and the average width 25 can for example be defined to half the height of the helical coils 12. The core diameter 22, the height of the helical coils 12 and the depth 23 of the helical grooves 14 remains constant along the entire delivery region 15. The average thickness 24 of the helical coils 12 and the average width 25 of the helical grooves 14 preferably also remain constant along the entire delivery region 15.

The delivery region 15 merges into the fastening region 16 in the direction of impact 8 in the drill bit 1 represented as an example. The drilling head 2 is soldered or welded on the preferably flat end face of the fastening region 16. The helix slope 19 increases continuously in the fastening region 16. The helix slope 19 preferably merges into an orientation parallel to the drill-bit axis 6. The cross-section of the helix 3 in the fastening region 16 can remain constant over its entire length. The cross-section of the fastening region 16 is preferably congruent to the cross-section in the delivery region 15. The core diameter 22, the height of the helical coils 12 and the depth 23 of the helical grooves 14 are in particular preferably constant.

In the outlet region 17 of the helix 3, the helical coils 12 merge from the delivery region 15 into the cylindrical insertion end 4. The outlet region 17 is divided along the drill-bit axis 6 into a curved portion 26 and a straight portion 27. The curved portion 26 borders on the delivery region 15, the straight portion 27 borders on the cylindrical insertion end 4. FIG. 4 shows a cross-section through the curved portion 26 in the plane IV-IV, FIG. 5 shows a first cross-section through the straight portion 27 in the plane V-V and FIG. 6 shows a second cross-section through the straight portion 27 in the plane VI-VI. The cross-sections are on the scale 2:1 with respect to the representation of FIG. 1, FIG. 7 shows a longitudinal portion along the drill-bit axis 6 through the outlet region 17.

The helical coils 12 run in the straight portion 27 continuously parallel to the drill-bit axis 6, i.e., at a helix slope 19 of 90 degrees. The helical coils 12 and the helical grooves 14 form their shape in the straight portion 27. The height of the helical coils 12 and the depth 18 of the helical grooves 14 reach, in the straight portion 27, the values of the delivery region 15. The bordering shaft 18 is cylindrical with a shaft diameter 28. The helical coils 12 increase with respect to the shaft diameter 28 and the bottoms of the helical grooves 14 decrease with respect to the shaft diameter 28 in the direction of impact 8. The helix 3 already reaches the cross-section inside the straight portion 27, the cross-section advancing in the delivery region 15. In particular, the cross-section reaches the helix diameter 21, the core diameter 22 and the depth 18 of the helical grooves 14. The height of the helical coils 12 or the depth 18 of the helical grooves 14 reaches, for example, between 20% and 25% of the helix diameter 21. The straight portion 27 preferably has a length 29 which corresponds to between one quarter and triple the pitch 20 in the delivery region 15, preferably the length 29 is greater than the pitch 20. The helical coils 12 running parallel to the drill-bit axis 6 and straight have proven favorable for the stability of the drill-bit 1 with respect to bending loads. The bending loads occur, for example when the user does not guide the drill-bit 1 exclusively parallel to the drill-bit axis 6, but rather for example allows it to hang transverse to the drill-bit axis 6, for example due to the weight of the drilling machine on the drill bit 1.

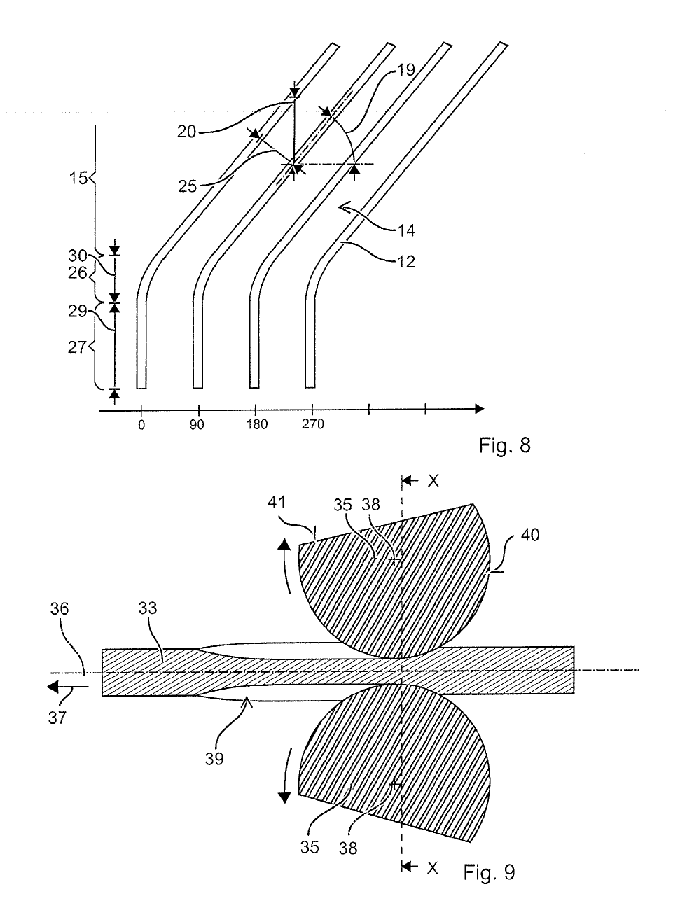

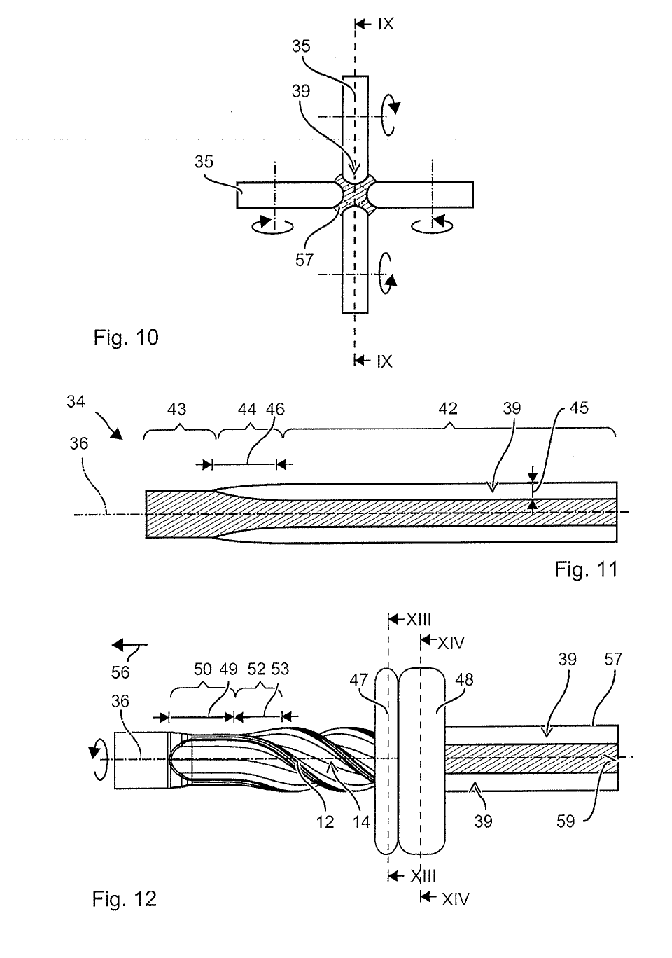

In the curved portion 26 of the outlet region 17, the helical slope 19 is continually reduced. The helical coils 12 merge from orientation parallel to the drill-bit axis 6 into orientation of the delivery region 15 inclined to the straight portion 27. The change of the helix slope 19 is illustrated in FIG. 8 in a rolled representation of the four-start helix 3. The length 30 of the curved portion 26 is greater than 25% of the pitch 20, preferably greater than 50% of the pitch 20. The slow adaptation of the helix slop 19 improves the bending capacity of the helix 3. The length 30 is preferably less than 100% of the pitch 20. The change of the helix slope 19 can be indicated in relation to the revolution angle of the helical coil 12 in the direction of rotation 5. The helix slope 19 preferably increases between 0.5 degrees and 2 degrees for each degree that the helical coil 12 winds around the drill-bit axis 6. The change rate can be constant.

The exemplary insertion end 4 of the drill-bit 1 is designed for the use of rotary chiseling hand-held power tools. The insertion end 4 has two closed grooves 31 in which locking elements of the hand-held power tool engage radially and can slide along the drill-bit axis 6. Coils 32 oriented longitudinally to the drill-bit axis 6 allow a torque to be introduced from the hand-held power tool.

An exemplary production method begins with a rod-shaped and cylindrical blank 33. The blank preferably has a cross-sectional area which is roughly equal to or up to 50% greater than the cross-sectional area of the helix 3. The length of the blank 33 is for example roughly in the range between the length 34 of the helix 3 and the length of the drill bit 1. The blank 33 preferably consists of a low-alloy steel.

The blank 33 is supplied to a first roll stand and converted into a semi blank 34 (FIG. 9). The roll stand has a plurality of rollers 35 which roll parallel to the axis 36 of the blank 33. The rollers 35 rotate around rotational axes 38 correspondingly perpendicular to the direction of advance 37 and axis 36. The rollers 35 generate longitudinal grooves 39 parallel to the axis 36 in the semi blank 34.

The exemplary rollers 35 have a circular segment 40 along their circumference to convert the blank 33 and a flat segment 41. The rollers 35 are aligned with the flat segments 41 facing the blank 33. The distance of the flat segments to the axis 36 is greater than the radius of the blank 33 such that the blank 33, without being converted, can be inserted along the axis 36 between the rollers 35. The blank 33 is pushed between the rollers 35 for a predetermined stretch. The rollers 35 are now pivoted whereby the circular segments engage into the blank 33 and convert the blank 33. The distance of the circular segments to the axis 36 is correspondingly less than the radius of the blank 33. The rollers 35 drive the blank 33 into the direction of advance 37 until the blank 33 falls between the rollers 35.

The longitudinal grooves 39 are introduced into a portion 42 of the blank 33 to be converted. A portion 43 of the blank 33 to be left unchanged remains unprocessed. The longitudinal grooves 39 have a transition region 44 between the converted portion 43 and the unchanged portion 43. In the transition region 44, the cross-section continually changes from the converted portion 42 to the unchanged portion 43. The depth 45 is achieved by means of a distance 46 which corresponds to one fifth up to one half of the depth 45.

As an alternative to rolling, the longitudinal grooves can be introduced into the blank by means of extrusion. A matrix has a funnel-shaped inflow opening. The opening tapers up to a cross-section corresponding to the complementary part to the first portion of the semi blank. The funnel shape of the matrix is complementary to the transition region. The matrix is accordingly at least as long as the transition region. The groove bottom increases preferably continuously in the transition region. The shape of the groove bottom along the axis can be circular-segment shaped or increasing continuously in a straight line.

The semi blank 35 is then twisted only in the converted portion 42. The twisting takes place for example using a matrix 47 and a support matrix 48. The portion 42 of the semi blank 35 to be converted is pushed into the matrix 47 and the support matrix 48. The matrix 47 has a distance 49 to the unchanged portion 43. The distance can for example be between one and three times the latter pitch 20 of the helix 3. A partial portion 50 of the converted portion 42 is not twisted, but rather maintains its straight longitudinal grooves 39. The partial portion 50 has at least the transition region 44, the partial portion 50 is preferably longer than the transition region. The longitudinal grooves 51 already reach their full depth 45 in the partial portion 50.

The matrix 47 is pivoted around a pivot axis with respect to the support matrix 48 in the direction of rotation 5 of the helix 3. The semi blank 35 is removed from the matrix 47 and the support matrix 48 whereby the portion 42 to be converted twists into the helix 3. The pivot angle is continually increased up to a set point value at the beginning inside a second partial portion 52 and then kept constant. The length 53 of the second partial portion 52 is between one quarter and one pitch 20 of the helix 3 to be produced. The set point value for pivoting predefines the helix slope 19 in cooperation with the inner geometry of the matrix 47. The helix slope 19 changes in the second partial portion 52 at a low rate along the drill-bit axis 6 or the direction of rotation 5 of the helix 3. The rate is preferably in the range of between 0.25 degrees and 2.0 degrees with each degree that the helix 3 winds around the drill-bit axis 6. For example, the helix slope 19 changes from 90 degrees to 45 degrees within one-eighth of a rotation of the helix 3, i.e., at an average rate of 1.0 degree per degree.

The support matrix 48 has a prismatic passage opening 54 (FIG. 13). The hollow cross-section of the passage opening preferably corresponds to the cross-section of the converted portion 27 of the semi blank 35 or to the cross-section of the helix 3. The support matrix 48 can be pushed in a sliding manner on the semi blank 35 without converting it and with preferably little clearance. The inner surfaces of the support matrix 48 are preferably parallel to the axis 36.

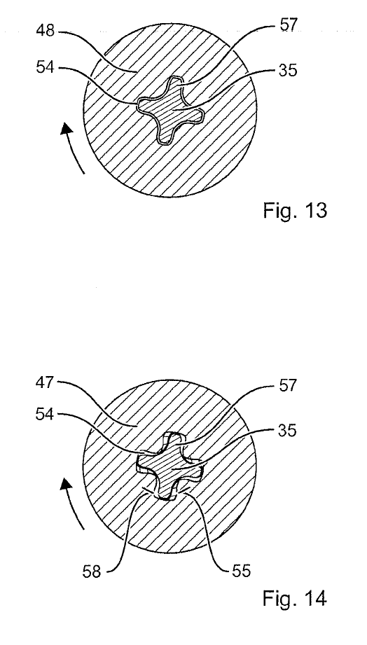

The matrix 47 has a passage opening 54 which allows the semi blank 35 to be inserted into the matrix 47 without effort (FIG. 14). The passage opening 54 has a prismatic cavity, whose hollow cross-section corresponds to the cross-section of the converted portion 27 of the semi blank 35, i.e., to the cross-section of the helix 3. The inner surfaces 55 facing away from the direction of rotation 5 are inclined such that the cross-section tapers along the pull-out direction 56. When the matrix 47 is pivoted, the inclined inner surfaces 55 press on the straight coils 57 of the semi blank 35. The coils 57 are supported in the support matrix 48 whereby the coils 32 are mainly converted inside the matrix 47. The matrix 47 serves only to twist the straight coils 32, the depth 45 of the longitudinal grooves 39 is largely maintained and is transferred into the depth of the helical grooves 14. The inner surfaces 58 facing the direction of rotation 5 are preferably parallel to the axis 36.

The one end of the semi blank 35 on the side of the matrix 47 rotates owing to the conversion with respect to the support matrix 48 and the other end 59 of the semi blank 35. A drive can support the rotational movement.

A drilling head 2, preferably made of tungsten carbide, is welded or soldered on the free end 59 of the semi blank 35.

1.-12. (canceled)

13. A drill bit, comprising:
a drilling head, a helix made of two or more helical coils, and an insertion end disposed along a drill bit axis, wherein the helix, in a delivery region, has a slope and a pitch;
wherein in an outlet region of the helix, the outlet region is directed toward the insertion end and the two or more helical coils merge continuously, within a first portion of the outlet region, from an orientation in alignment with the slope into an orientation parallel to the drill bit axis;
wherein a length of the first portion is at least one quarter of the pitch;
wherein the two or more helical coils are, in a second portion of the outlet region, oriented parallel to the drill-bit axis.

14. The drill bit according to claim 13, wherein the delivery region and the first portion have a cross-section that is constant.

15. The drill bit according to claim 13, wherein helical grooves, defined by respectively adjacent helical coils of the two or more helical coils, in the delivery region and the first portion have a constant depth.

16. The drill bit according to claim 13, wherein in the first portion, the slope decreases with respect to the drill bit axis at a rate of between 0.25 degrees and 2 degrees for each degree in a direction of rotation of the helix.

17. The drill bit according to claim 16, wherein in the first portion, the slope continually decreases in the direction of rotation of the helix from a slope of 90 degrees to a slope of between 30 degrees and 70 degrees.

18. The drill bit according to claim 13, wherein a length of the second portion is between one quarter of the pitch and triple the pitch.

19. The drill bit according to claim 13, wherein a cross-section of the second portion is constant over at least half of a length of the second portion.

20. The drill bit according to claim 13, wherein the drilling head is a sintered carbide.

21. The drill bit according to claim 20, wherein the drilling head has break-off edges parallel to the drill-bit axis.

22. A production method for a drill bit with a helix and an insertion end, comprising the steps of:
converting a cylindrical blank by forming a plurality of longitudinal grooves oriented parallel to an axis of the cylindrical blank into the cylindrical blank;
twisting the plurality of longitudinal grooves by a twisting tool to generate the helix with a slope and a pitch in a delivery region;
converting, in a first portion of an outlet region of the helix, wherein a length of the first portion is at least one quarter of the pitch, the plurality of longitudinal grooves from an orientation parallel to the axis into an orientation in alignment with the slope; and
forming a second portion of the outlet region of the helix with the plurality of longitudinal grooves oriented parallel to the axis.

23. The method according to claim 22, wherein a length of the second portion is between one quarter of the pitch and triple the pitch.

24. The method according to claim 22, wherein the plurality of longitudinal grooves are shaped by rolling along the axis of the cylindrical blank.
